(19) United States
(12) Patent Application Publication
(10) Pub. No.: US 2012/0166222 A1
(43) Pub. Date: Jun. 28, 2012

(54) CONSOLIDATING INFORMATION FOR MANAGEMENT OF ANTICOAGULANT PATIENTS

(75) Inventors: Jason Howard, Lee's Summit, MO (US); Hugh Ryan, Lee's Summit, MO (US)

(73) Assignee: CERNER INNOVATION, INC., Overland Park, KS (US)

(21) Appl. No.: 12/979,488

(22) Filed: Dec. 28, 2010

(51) Int. Cl. G06Q 50/00

(52) U.S. Cl. 705/3

(57) ABSTRACT

A method, system, medium, and graphical user interface are provided for managing treatment of patients on anticoagulant medications. Patients undergoing anticoagulant treatment are identified. A consolidated list of anticoagulant patients is generated. The list includes patient information, prescribed anticoagulant medications, reasons for treatment, and laboratory test values, among other data. It is determined that a laboratory test result associated with an anticoagulant medication is outside of a desired range. Guidelines associated with provision of the medication are identified and provided to a clinician via a graphical user interface. The GUI provides a centralized consolidated presentation of anticoagulant patient information that allows clinicians to more easily access the information and to more quickly identify activities to be performed for anticoagulant patients. Clinicians may also enter or change orders, document treatment, and receive alerts regarding treatment of anticoagulant patients.

### BACKGROUND

Anticoagulant medications, or simply, anticoagulants are widely used in the healthcare industry. Anticoagulants, as described herein, are substances the prevent clotting or coagulation of blood in the human body. These substances include medications such as warfarin (Coumadin) or other vitamin K antagonists, heparin, heparin derivates, and direct thrombin inhibitors, among others known in the art. Anticoagulants are often prescribed for treatment of patients suffering from, or at risk for conditions like atrial fibrillation, pulmonary embolism, deep vein thrombosis, venous thromboembolism, congestive heart failure, stroke, and myocardial infarction, to name a few.

The prevalence of patients in a healthcare facility receiving anticoagulant treatment is often high. For example, it is not uncommon for forty to sixty percent of patients in a healthcare facility to be undergoing anticoagulant treatment. As such, management of anticoagulant treatment in a healthcare facility is no small task.

Additionally, due to small therapeutic ranges for anticoagulant treatments, high patient acuity, and other factors associated with the drugs or patients themselves, anticoagulant medications are deemed to be high-alert or high-risk medications. Studies have shown these medications to be responsible for more than twice as many preventable adverse drug events than any other drug class. Further, ineffective management of anticoagulant treatment of a patient can lead to prolonged hospital stays and increased costs to the patient and hospital among a host of other potential undesirable complications and outcomes.

### SUMMARY

Embodiments of the invention are defined by the claims below, not this summary. A high-level overview of various aspects of the invention are provided here for that reason, to provide an overview of the disclosure, and to introduce a selection of concepts that are further described below in the detailed-description section below. This summary is not intended to identify key features or essential features of the claimed subject matter, nor is it intended to be used as an aid in isolation to determine the scope of the claimed subject matter.

Embodiments of the invention provide methods, systems, media, and graphical user interfaces (GUI) for management of anticoagulant treatments for inpatients and/or outpatients of a healthcare facility. Patients taking anticoagulant medications or for which an order has been placed for anticoagulant medications are identified from electronic medical records (EMR). A consolidated list of anticoagulant patients and associated data elements including an indication of the anticoagulant(s) the patient is taking, the reason or indication for taking the anticoagulant(s), and laboratory test values associated with the efficacy of the prescribed anticoagulant(s) is generated. The list might also include an indication of baseline laboratory test values, an indication of whether current laboratory test values are within a desired range, and documentation of a treating clinician and the treatment provided by the clinician.

In embodiments of the invention, it is also determined that a patient requires adjustment of a prescribed dosage of an anticoagulant based on, for example a laboratory test value. Appropriate guidelines are identified and are provided to a clinician via a GUI. Additionally, a new dosage might be determined and an alert provided to a clinician to notify of the required adjustment. Risk factors for treatment of the patient with one or more anticoagulants might also be identified based on the data elements in the patient's EMR. Consolidated anticoagulant patient information, guidelines, and recommendations are provided to clinicians via a GUI in which the clinician can identify, follow, manage, and document the treatment of patients undergoing anticoagulant therapies.

### DESCRIPTION OF THE DRAWINGS

Illustrative embodiments of the invention are described in detail below with reference to the attached drawing figures, and wherein:

FIG. 1 is a block diagram depicting an exemplary operating environment suitable for use in accordance with an embodiment of the invention;

FIG. 2 is a block diagram depicting an exemplary network architecture suitable for use in accordance with an embodiment of the invention;

FIG. 3 is a block diagram depicting an anticoagulant management system for managing anticoagulant medications for patients in a healthcare facility in accordance with an embodiment of the invention;

FIGS. 4A-C are graphical illustrations of a graphical user interface for use in managing anticoagulant patients in accordance with an embodiment of the invention;

FIGS. 5A-B are graphical illustrations of a graphical user interface displaying an anticoagulant patient summary in accordance with an embodiment of the invention; and

FIG. 6 is a flow diagram depicting a method for managing anticoagulation treatment for patients in a healthcare system in accordance with an embodiment of the invention.

### DETAILED DESCRIPTION

The subject matter of embodiments of the invention is described with specificity herein to meet statutory requirements. But the description itself is not intended to necessarily limit the scope of claims. Rather, the claimed subject matter might be embodied in other ways to include different steps or combinations of steps similar to the ones described in this document, in conjunction with other present or future technologies. Terms should not be interpreted as implying any particular order among or between various steps herein disclosed unless and except when the order of individual steps is explicitly described.

Embodiments of the invention include methods, systems, computer-readable storage media, and graphical user interfaces (GUI). In an embodiment, computer-readable storage media having computer-executable instructions embodied thereon that, when executed, perform a of method for managing anti-coagulation treatment for a patient is provided. A patient that is taking an anticoagulant medication or for which an anticoagulant medication has been ordered is identified based on data elements in an electronic medical record (EMR) associated with the patient. A consolidated list of a plurality of patients that are receiving anticoagulant medications is generated. The plurality of patients includes the patient and the list includes for each of the plurality of patients an indication of a prescribed anticoagulant medication, a reason for the anticoagulant medication being taken, and a lab value that represents the efficacy anticoagulant medication treatment in a respective patient. It is determined that the patient requires adjustment of a prescribed dosage of the anticoagulant medication. Guidelines associated with the anticoagulant medication are identified. The consolidated list and the guidelines are provided to a clinician via a graphical user interface (GUI).

In another embodiment, computer-readable storage media having computer-executable instructions embodied thereon that, when executed, provide a system for managing anticoagulant medications for patients in a healthcare facility is described. The system includes an anticoagulant-patient identification component, a risk assessment component, an advisor component, a list generation component, and a presentation component. The anticoagulant-patient identification component identifies a patient in a healthcare facility that is currently prescribed an anticoagulant medication or for which an order has been placed for an anticoagulant medication based on data elements stored in an EMR associated with the patient and gathers data elements related to the care of the anticoagulant patient from the EMR. The risk assessment component identifies potential risk factors for treatment of the anticoagulant patient with a given anticoagulant medication. The advisor component determines a guideline associated with the anticoagulant medication prescribed to the anticoagulant patient and provides the guideline to a clinician. The list generation component generates a consolidated list of a plurality of anticoagulant patients and related data elements. The related data elements include at least an identification of at least one anticoagulant medication prescribed for the patient, a reason the patient is prescribed the anticoagulant medication, and a lab value associated with the anticoagulant medication. The presentation component provides a centralized GUI from which a clinician accesses the consolidated list, potential risk factors, and guidelines.

In another embodiment, a GUI stored on one or more computer-readable media and executable by a computing device having a processor for providing a consolidated presentation of data from EMR associated with each of a plurality of patients receiving an anticoagulant medication in a healthcare facility is provided. The GUI includes a first display area configured to display patient information for each of a plurality of patients receiving an anticoagulant medication in a healthcare facility including patient identification information and a second display area configured to display an indication of a reason each of the plurality of patients is receiving the anticoagulant medication. The GUI also includes a third display area configured to display the anticoagulant medication prescribed to each of the plurality of patients, a fourth display area configured to display at least one lab result associated with the prescribed anticoagulant medication, and a fifth display area configured to display an indication of a clinician that last followed up on a respective patient, and to provide access to notes regarding the care of the respective patient.

In the treatment of patients, a clinician, such as a medical doctor is typically in charge of and responsible for the care of the patient. However, other clinicians, e.g. pharmacists and nurses, are also involved in the care of the patient. For patients on anticoagulant medications pharmacists are often directly involved in overseeing and recommending management of the anticoagulant medications to the treating physician. In some situations, the pharmacist provides full management of the anticoagulant medications while the physician merely oversees and signs off on the pharmacist's recommendations.

Studies have shown that pharmacy management and/or close involvement in the care of anticoagulant patients improves patient care and outcomes. As such, healthcare facilities may recommend or require pharmacy management of anticoagulant patients. This may be a result of a variety of factors including insufficient time available for the treating physician to reference appropriate guidelines and identify appropriate dosages or actions to control laboratory test results, insufficient knowledge by the treating physician of guidelines and recommendations for treatment, complex guidelines, considerable drug interaction considerations, and retention of outdated practices, among others.

Transfer of duties involved in management of anticoagulant patients to pharmacists can alleviate some time and knowledge issues of treating physicians, however, due at least to the number of patients receiving anticoagulant treatment this can also be burdensome to pharmacists. Embodiments of the invention assist pharmacists and other clinicians in management of anticoagulant patients by consolidating information related to anticoagulant patients and presenting a GUI that allows the pharmacist, or other clinician, to quickly identify appropriate patients, laboratory test values, actions, guidelines, and other information that needs to be considered.

In contrast, using prior art systems, pharmacists must identify anticoagulant patents, obtain information regarding the anticoagulant patients, and obtain guidelines and recommendations from multiple sources, both electronic and paper-based. As such, prior art systems are time consuming and open to error.

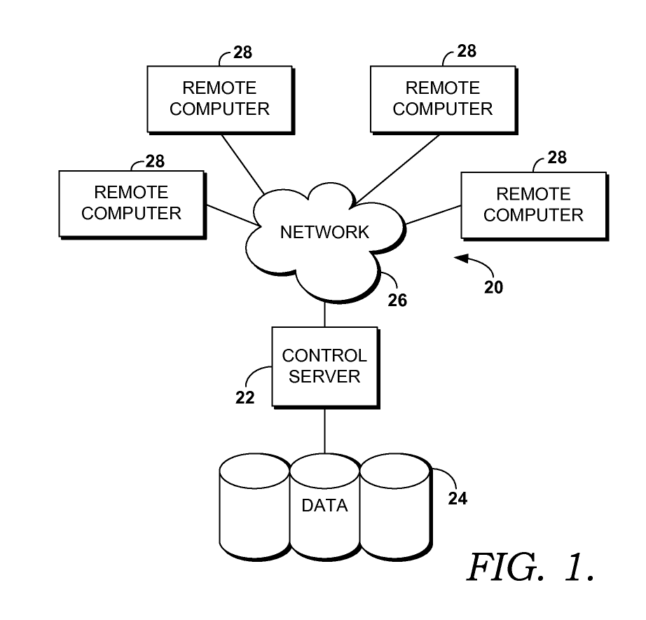

Having briefly described embodiments of the present invention, an exemplary operating environment suitable for use in implementing embodiments of the present invention is described below. Referring to the drawings in general, and initially to FIG. 1 in particular, an exemplary computing system environment, a medical information computing system environment, with which embodiments of the present invention may be implemented is illustrated and designated generally as reference numeral 20. It will be understood and appreciated by those of ordinary skill in the art that the illustrated medical information computing system environment 20 is merely an example of one suitable computing environment and is not intended to suggest any limitation as to the scope of use or functionality of the invention. Neither should the medical information computing system environment 20 be interpreted as having any dependency or requirement relating to any single component or combination of components illustrated therein.

The present invention may be operational with numerous other general purpose or special purpose computing system environments or configurations. Examples of well-known computing systems, environments, and/or configurations that may be suitable for use with the present invention include, by way of example only, personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

The present invention may be described in the general context of computer-executable instructions, such as program modules, being executed by a computer. Generally, program modules include, but are not limited to, routines, programs, objects, components, and data structures that perform particular tasks or implement particular abstract data types. The present invention may also be practiced in distributed computing environments where tasks are performed by remote processing devices that are linked through a communications network. In a distributed computing environment, program modules may be located in association with local and/or remote computer storage media including, by way of example only, memory storage devices.

With continued reference to FIG. 1, the exemplary medical information computing system environment 20 includes a general purpose computing device in the form of a control server 22. Components of the control server 22 may include, without limitation, a processing unit, internal system memory, and a suitable system bus for coupling various system components, including database cluster 24, with the control server 22. The system bus may be any of several types of bus structures, including a memory bus or memory controller, a peripheral bus, and a local bus, using any of a variety of bus architectures. By way of example, and not limitation, such architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The control server 22 typically includes therein, or has access to, a variety of computer-readable media, for instance, database cluster 24. Computer-readable media can be any available non-transitory media that may be accessed by server 22, and includes volatile and nonvolatile media, as well as removable and non-removable media. By way of example, and not limitation, computer-readable media may include computer storage media. Computer storage media may include, without limitation, volatile and nonvolatile media, as well as removable and non-removable media implemented in any method or technology for storage of information, such as computer-readable instructions, data structures, program modules, or other data. In this regard, computer storage media may include, but is not limited to, RAM, ROM, EEPROM, flash memory or other memory technology, CD-ROM, digital versatile disks (DVDs) or other optical disk storage, magnetic cassettes, magnetic tape, magnetic disk storage, or other magnetic storage device, or any other non-transitory medium which can be used to store the desired information and which may be accessed by the control server 22. Combinations of any of the above also may be included within the scope of computer-readable media.

The computer storage media discussed above and illustrated in FIG. 1, including database cluster 24, provide storage of computer-readable instructions, data structures, program modules, and other data for the control server 22. The control server 22 may operate in a computer network 26 using logical connections to one or more remote computers 28. Remote computers 28 may be located at a variety of locations in a medical or research environment, for example, but not limited to, clinical laboratories (e.g., molecular diagnostic laboratories), hospitals and other inpatient settings, veterinary environments, ambulatory settings, medical billing and financial offices, hospital administration settings, home health care environments, and clinicians' offices. Clinicians may include, but are not limited to, a treating physician or physicians, specialists such as neonatologists, surgeons, radiologists, cardiologists, and oncologists, emergency medical technicians, physicians' assistants, nurse practitioners, nurses, nurses' aides, pharmacists, dieticians, microbiologists, laboratory experts, laboratory technologists, genetic counselors, researchers, veterinarians, students, and the like. The remote computers 28 may also be physically located in non-traditional medical care environments so that the entire health care community may be capable of integration on the network. The remote computers 28 may be personal computers, servers, routers, network PCs, peer devices, other common network nodes, or the like, and may include some or all of the elements described above in relation to the control server 22. The devices can be personal digital assistants or other like devices.

Exemplary computer networks 26 may include, without limitation, local area networks (LANs) and/or wide area networks (WANs). Such networking environments are commonplace in offices, enterprise-wide computer networks, intranets, and the Internet. When utilized in a WAN networking environment, the control server 22 may include a modem or other means for establishing communications over the WAN, such as the Internet. In a networked environment, program modules or portions thereof may be stored in association with the control server 22, the database cluster 24, or any of the remote computers 28. For example, and not by way of limitation, various application programs may reside on the memory associated with any one or more of the remote computers 28. It will be appreciated by those of ordinary skill in the art that the network connections shown are exemplary and other means of establishing a communications link between the computers (e.g., control server 22 and remote computers 28) may be utilized.

In operation, a clinician may enter commands and information into the control server 22 or convey the commands and information to the control server 22 via one or more of the remote computers 28 through input devices, such as a keyboard, a pointing device (commonly referred to as a mouse), a trackball, or a touch pad. Other input devices may include, without limitation, microphones, satellite dishes, scanners, or the like. Commands and information may also be sent directly from a remote healthcare device to the control server 22. In addition to a monitor, the control server 22 and/or remote computers 28 may include other peripheral output devices, such as speakers and a printer.

Although many other internal components of the control server 22 and the remote computers 28 are not shown, those of ordinary skill in the art will appreciate that such components and their interconnection are well known. Accordingly, additional details concerning the internal construction of the control server 22 and the remote computers 28 are not further disclosed herein.

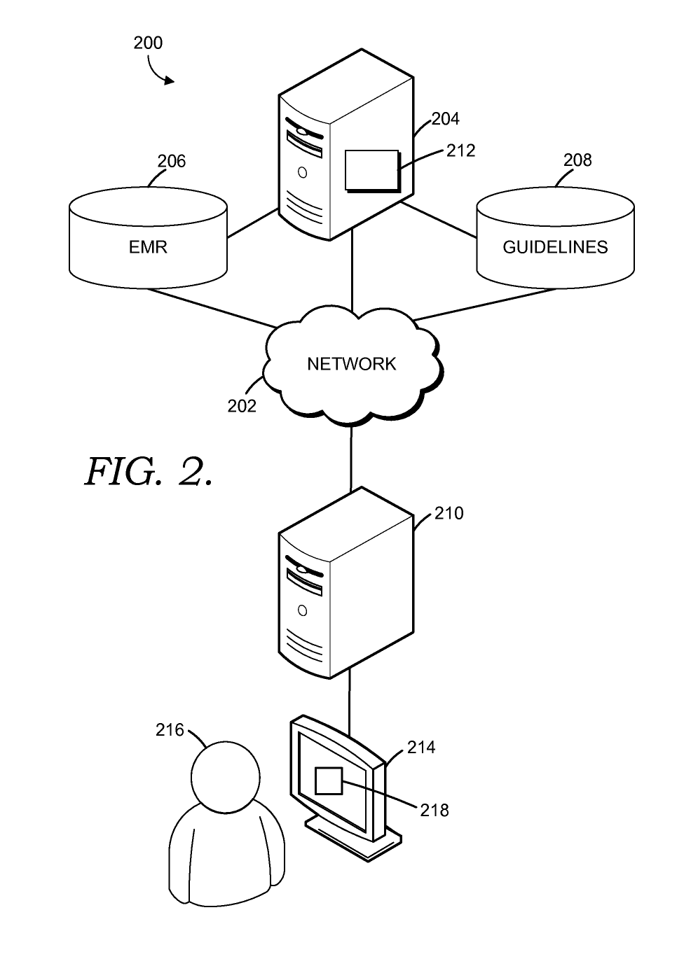

With additional reference now to FIG. 2, an exemplary network architecture 200 suitable for use in embodiments of the invention is described. The network architecture 200 may reside within or comprise the medical information computing system environment 20 described above. The network architecture 200 is one example, of which there are many, that can be used to implement embodiments of the invention. Components of the network architecture 200 are depicted singularly for clarity but, in practice, may include a plurality of similar or dissimilar components that are configured to perform the functions described below. Additionally, one or more of the components or the functions thereof can be integrated into a single component or further divided into a plurality of subcomponents. The network architecture 200 is not intended to limit components or network architectures that can be employed in embodiments of the invention. One of skill in the art will recognize other components and architectures that are suitable for use in embodiments of the invention.

The network architecture 200 includes a network 202, a network computing device 204, an Electronic Medical Record (EMR) database 206, a guidelines database 208, and a user's computing device 210. The network 202 includes any available network, such as for example, an intranet, the Internet, an ethernet, a local area network, and the like as described above. In an embodiment, the network 202 is a secure local area network of a healthcare system such as a hospital.

The network computing device 204 is any one or more computing device(s), such as the control server 22, described above. The network computing device 204 is communicatively coupled either directly or indirectly to the network 202, the EMR database 206, and the guidelines database 208. The network computing device 204 is configured to receive patient data, e.g. data related to a patient or to the care of the patient, and to store such data in the EMR database 206. The patient data is supplied to the network computing device 204 by users in a healthcare system via the network 202 or directly to the network computing device 204. The users include clinicians, hospital administrative users, and the like.

In an embodiment, the network computing device 204 also includes algorithms, procedures, or rules for identifying one or more medical conditions of a patient based on the patient data received thereby. Or medical conditions can be specified by clinicians and input to the network computing device 204 thereby. The determined or received medical conditions are also stored to the EMR database 206.

Additionally, the network computing device 204 is configured via one or more applications or components 212 to identify patients that are prescribed an anticoagulant or for which an order has been entered for anticoagulant treatment or pharmacy management based on data elements contained in the EMR database 206. In an embodiment, the component 212 is configured to abstract patient data that is input to the EMR database 206 to determine and identify data that indicates a patient as an anticoagulant patient. Abstraction of the data includes utilizing relationships between associated data elements, characteristics of the data elements, and the like.

The guidelines database 208 includes any one or more databases or memory stores that store guidelines and recommendations associated with anticoagulant medications. The guidelines database 208 is internal and/or external to a healthcare facility. The guidelines and recommendations are obtained from any available source including, for example, and not limitation, medical publications or journals, government organizations, research organizations, and the like.

Anticoagulant guidelines and recommendations include any teachings, protocols, or other guidance usable in identifying patients as candidates for anticoagulant treatment and for providing such treatment. These may include therapeutic ranges, dosages, ideal laboratory test value ranges, procedures for weaning, or procedures for drug management, and the like.

With continued reference to FIG. 2, the network architecture 200 also includes the user's computing device 210. The user's computing device is any available computing device, such as the control server 22 or the remote computers 28 of FIG. 1. In an embodiment, the user's computing device 210 and the network computing device 204 are the same computing device. The user's computing device 210 is communicatively coupled to the network 202 and thereby to the network computing device 204, the EMR database 206 and the guidelines database 208. The user's computing device 210 includes an associated display device 214 and is operated by a user or clinician 216. The display device 214 is any display device available in the art suitable for providing a display to the clinician 216 of a user interface 218, as described more fully below.

The user's computing device 210 is employed by the clinician 216 to access and interact with an EMR for a patient. An EMR is an electronic version of a patient's medical record or chart as is known in the art. The EMR presents patient data for a respective patient that is stored in the EMR database 206 and allows clinicians 216 to input, alter, access, or otherwise interact with the patient data. Patient data in the EMR may include information obtained a single healthcare facility or multiple healthcare facilities and other sources. The EMR is provided by any available applications and in any desired format known in the art. In an embodiment, the EMR is presented in a web page-style format and includes an initial page or portal that is presented to the clinician 216 upon accessing the EMR. Such an EMR presentation may employ hypertext markup language (HTML), Java script, or any other available coding.

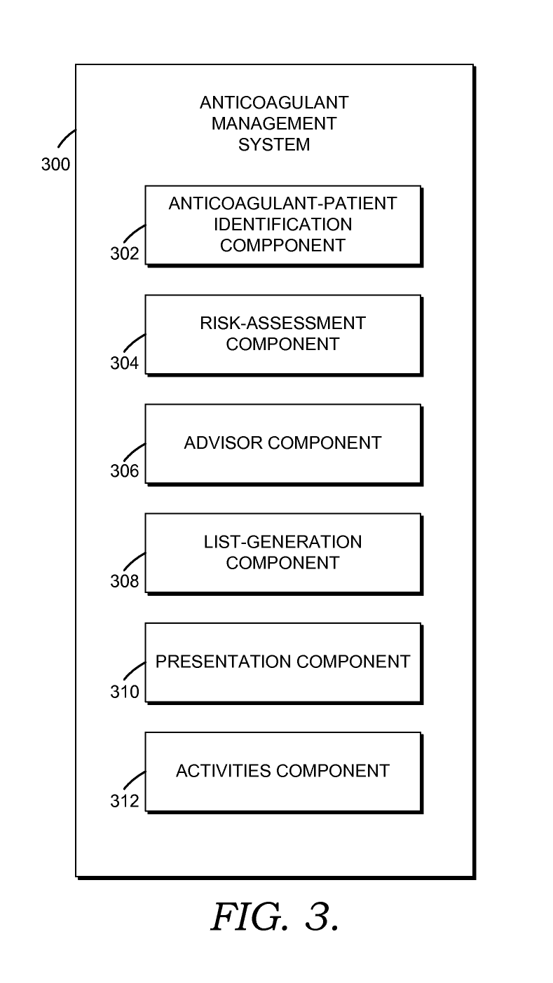

With reference now to FIG. 3, an anticoagulant management system 300 for managing anticoagulant medications for patients in a healthcare facility is described in accordance with an embodiment of the invention. The system 300 identifies anticoagulant patients and gathers patient data, guidelines, and recommendations associated with the anticoagulant treatment of the patient and presents the information to clinicians in a consolidated form via a GUI. The system 300 includes an anticoagulant-patient identification component 302, a risk-assessment component 304, an advisor component 306, a list-generation component 308, a presentation component 310, and an activities component 312. It is understood that one or more of the components 302-312 may be combined or removed in embodiments of the invention.

The anticoagulant-patient identification component 302 is configured to identify patients in a healthcare facility or system as anticoagulant patients. As referred to herein, an anticoagulant patient is any patient that is undergoing anticoagulant therapy or for which an order has been entered by a treating physician or pharmacist for anticoagulant therapy. The anticoagulant patient might also be any patient for which pharmacy management of the patient is ordered by a treating physician.

The anticoagulant therapy might be ordered based on any indication for treatment, such as for example, the patient suffering from atrial fibrillation, a cerebrovascular accident, deep venous thrombosis, myocardial infarction, pulmonary embolism, aortic valve replacement, and the like. Anticoagulant therapy might also be ordered prophylactically, such a for venous thromboembolism prophylaxis or based on a scheduled procedure or government regulation that requires provision of an anticoagulant to patients entering a healthcare facility, among others.

Anticoagulant therapy includes any one or more anticoagulant medications ordered for the patient. Exemplary anticoagulant medications include, but are not limited to, warfarin (Coumadin) or other vitamin K antagonists, heparin, heparin derivates, and direct thrombin inhibitors, among others known in the art. Anticoagulant medications are provided in any form (e.g. pill, tablet, intravenous) and concentration desired.

Identification of a patient as an anticoagulant patient is determined based upon data elements stored in an EMR for the respective patient. The data elements might indicate an anticoagulant medication that is prescribed or ordered for the patient, a diagnosis of the patient's condition, symptoms of the patient, laboratory test result values, or the like. In an embodiment, the anticoagulant-patient identification component 302 queries the EMR for all patients of the healthcare facility to identify a subset of all patients as anticoagulant patients.

The risk-assessment component 304 identifies potential risk factors for treatment of an identified anticoagulant patient generally or with respect to a given anticoagulant. The risk-assessment component 304 identifies potential risk factors based on one or more of an anticoagulant patient's medical history, symptoms and diagnosis of the patient's condition, laboratory test results, scheduled procedures, and other medications prescribed for the patient, among any other available data elements useful in identifying such risk factors. For example, the risk-assessment component 304 might identify data elements in the patient's EMR that indicate that the patient previously had a heart valve replacement and had an adverse reaction to heparin. Or the risk-assessment component 304 might determine that a patient is currently prescribed a medication that is included on a list of medications known to potentiate the anticoagulant warfarin.

Upon identification of a potential risk factor, the risk-assessment component 304 is configured to provide an alert to clinicians treating the patient. In one embodiment, the alert is provided as an indicator in an appropriate location in the patient's EMR, or by providing an email, text message, or page to a clinician, among others. The alert is visual and/or audible and can provide a simple symbolic indicator and/or provides any desired information including an indication of the identified risk factor, potential effects of continued treatment, and guidelines or recommendations for counteracting or balancing effects thereof. In addition, in an embodiment, the risk-assessment component 304 automatically provides an order for pharmacy management of an anticoagulant patient and/or an appropriate laboratory test to be performed on the patient when a potential risk factor is identified.

With continued reference to FIG. 3, the advisor component 306 is configured to determine guidelines and recommendations associated with prescribed anticoagulant medications and to provide the guidelines to a clinician. In an embodiment, the guidelines and recommendations are identified from those stored in the guidelines database 208 depicted in FIG. 2. As described above, the guidelines and recommendations comprise any available teachings, protocols, or other information for providing anticoagulants to patients and managing anticoagulant patient care. For example, the guidelines might include dosing guidelines for warfarin, warfarin reversal guidelines, heparin dosing guidelines, weaning procedures, and pre- and post-procedure bridging guidelines, among others. As such, the guidelines might include anticoagulant dosages, dosing procedures or timelines, and ideal or acceptable laboratory test result values.

In an embodiment, the guidelines and recommendations are employed to identify an anticoagulant patient that has laboratory test values outside of a desired range. The advisor component 306 is configured to provide an alert to clinicians of laboratory test values that are outside of a desired or recommended range. In another embodiment, the guidelines and recommendations are used to determine a new dosage of an anticoagulant to be provided to a patient. The advisor component 306 might also provide the new dosage to the clinician or may automatically provide an order for the new dosage. In such an embodiment, automatically calculating the new dosage and providing it to a clinician reduces or eliminates a number of instances in which errors might be made by clinicians.

For example, in an embodiment, heparin is provided to an anticoagulant patient via an intravenous drip infusion. A laboratory test is periodically completed to identify the activated partial thromboplastin time (aPTT) of the patient's blood. The heparin dosage is then adjusted to maintain the aPTT within a desired range, typically between 1.5 to 2.5 times a normal control. When the aPTT falls outside of the desired range that advisor component 306 identifies the occurrence and determines a new heparin dosage based on the aPTT and protocols for administration of heparin (such as those stored in the guidelines database 208).

In an embodiment, the advisor component also determines an appropriate dosage to prescribe based on characteristics of heparin supplies available at the healthcare facility. For example, the concentrations of available heparin supplies are considered to determine an appropriate infusion rate for a given concentration that will result in the provision of the appropriate dosage to the patient. The advisor component 306 then communicates an alert to a clinician, such as a nurse that indicates the out-of-range aPTT value and provides the new dosage, appropriate heparin supply to use and the infusion rate to be used.

As such, the nurse need only insure that the appropriate changes are made to the patient's heparin provisions. The nurse is not required to identify the out-of-range aPTT, identify the new dosage, or calculate the infusion rate based on available heparin supplies. Thereby, instances in which errors might be made and the time between identification of the out-of-range aPTT value and implementation of the new dosage are greatly decreased over prior art systems.

With further reference to FIG. 3, the list-generation component 308 is configured to generate a consolidated list of anticoagulation patients. As described above, the anticoagulant-patient identification component 302 identifies anticoagulant patients. These identified anticoagulant patients and data elements associated with the anticoagulant treatment of the patients are consolidated into a single list by the list-generation component 308.

The data elements associated with the treatment of the anticoagulant patients includes any such data gathered from the patient's EMR. These data elements include, for example, and not limitation, identification of one or more anticoagulants prescribed for the patient, an indication or reason for treatment of the patient with the anticoagulant, a laboratory test value associated with the anticoagulant treatment, an indication of a baseline laboratory test value, an indication of a treating clinician, a time when the treating clinician last rounded on or visited the patient, and documentation provided by the treating clinician, among other available information.

The presentation component 310 is configured to provide a graphical user interface (GUI) that includes the consolidated list, potential risk factors, guidelines, and alerts described above with respect to the components 302-308. The GUI is provided in any desired format and may employ any desired computer code, script, or software to produce the GUI. In an embodiment, the GUI is configured similarly to a webpage and utilizes hypertext markup language (HTML) and/or Java script. The GUI is accessed by clinicians in any desired manner including, for example, via a link in a anticoagulant patient's EMR or directly as a standalone application. In an embodiment, a portion of the information presented by the GUI is presented in an anticoagulant patient's EMR such as on a main startup page or portal page. The portion is useable to access the full GUI and might provide only the newest or most important information such as an alert.

The activities component 312 is configured to generate a list of activities to be completed for each of the identified anticoagulant patients. The activities include any acts to be carried out by a clinician in the care of the anticoagulant patient. These acts might include ordering a laboratory test, reviewing a laboratory test result, managing an anticoagulant dosage, following up with a treating physician, visiting the anticoagulant patient, and educating the anticoagulant patient. In an embodiment, the activities component 312 also provides an indication in the GUI that informs a clinician of a completion status of one or more activities.

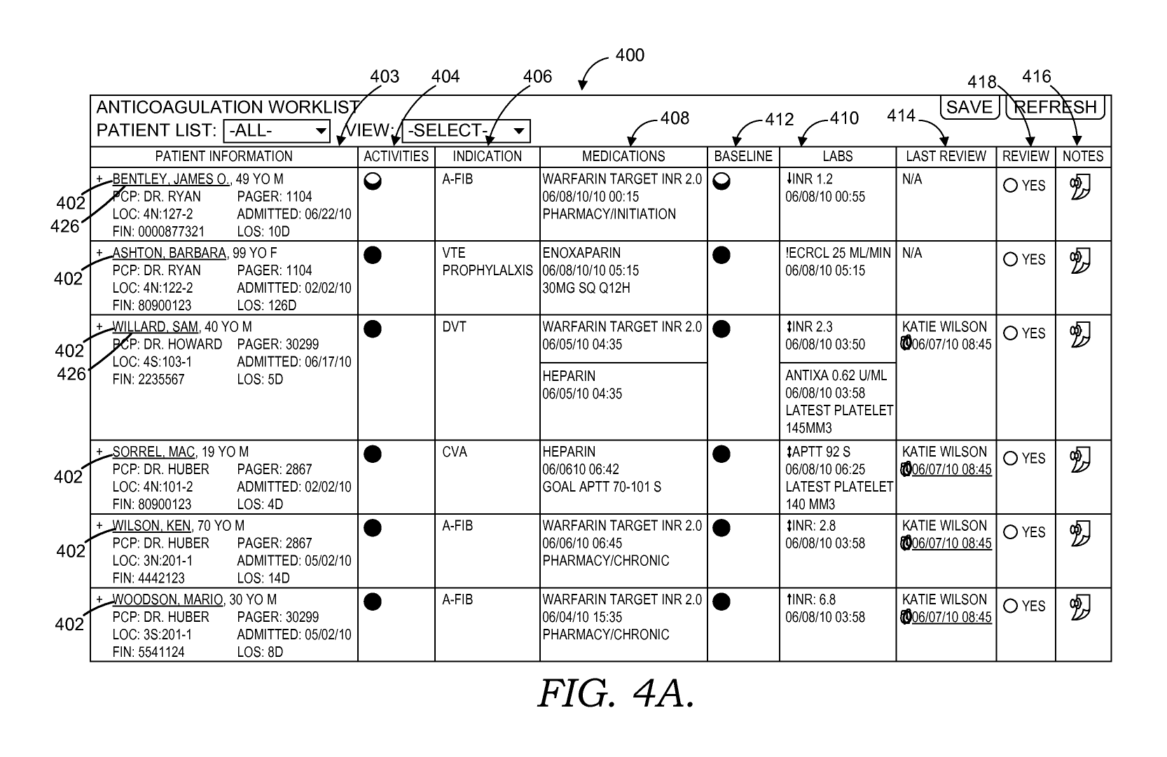

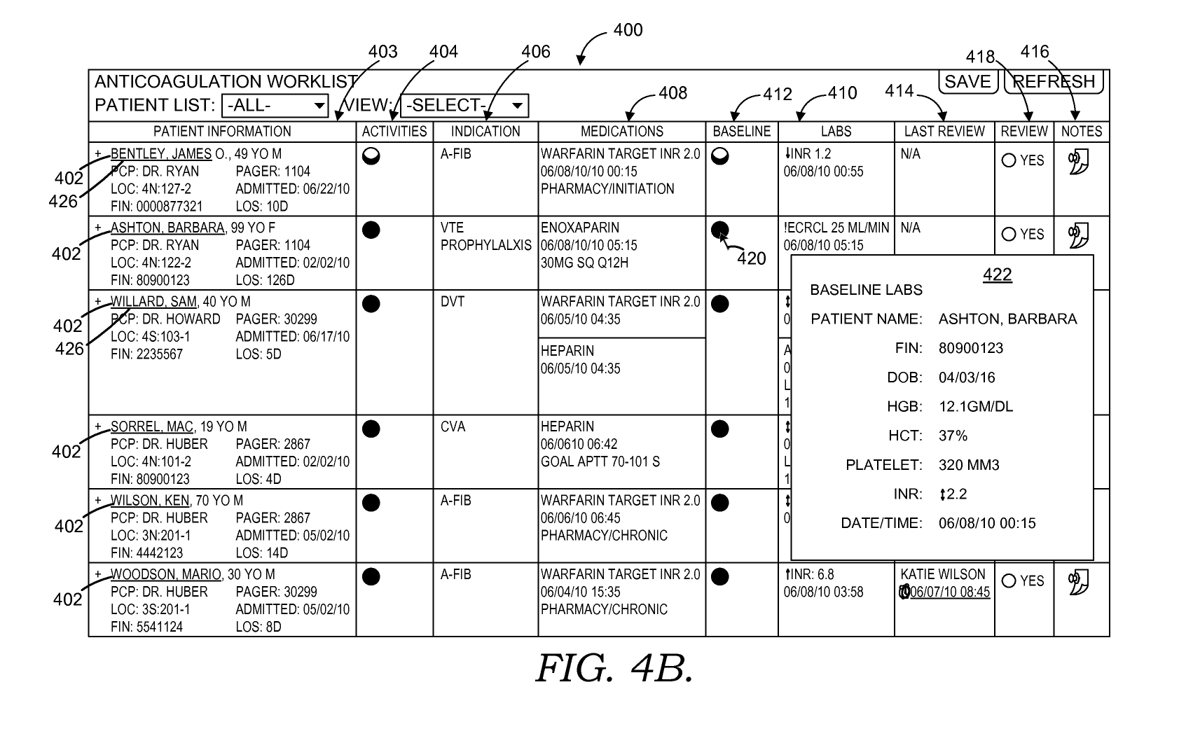

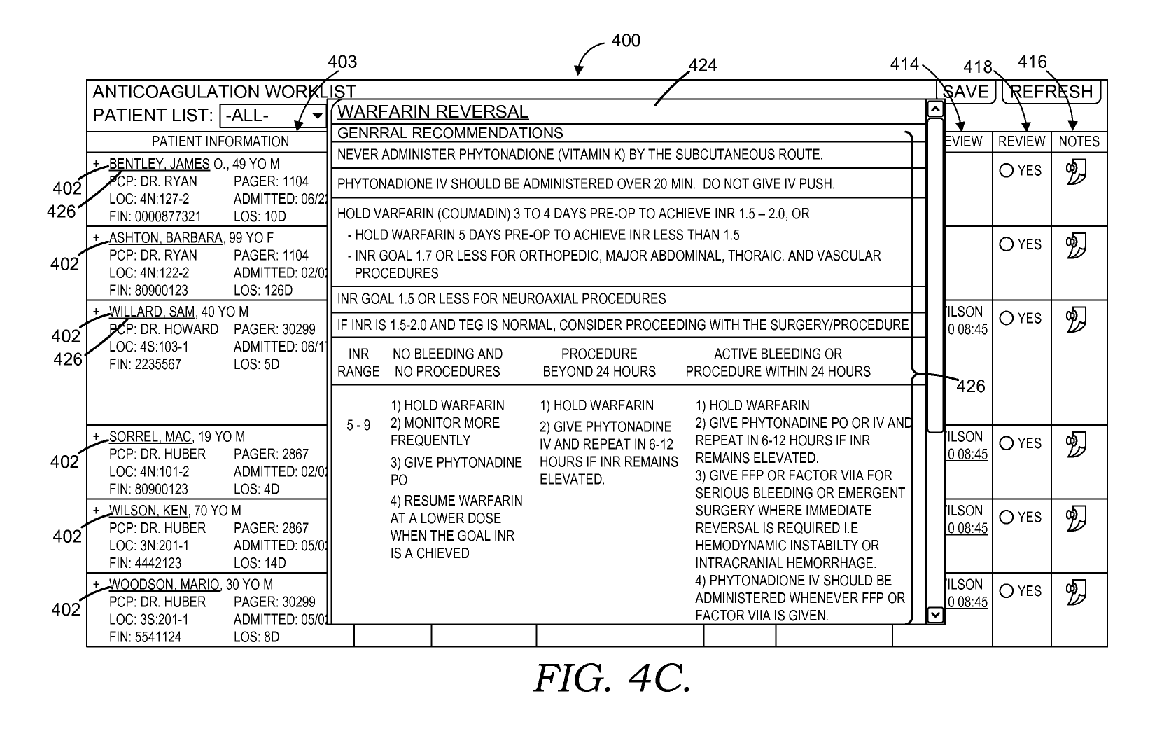

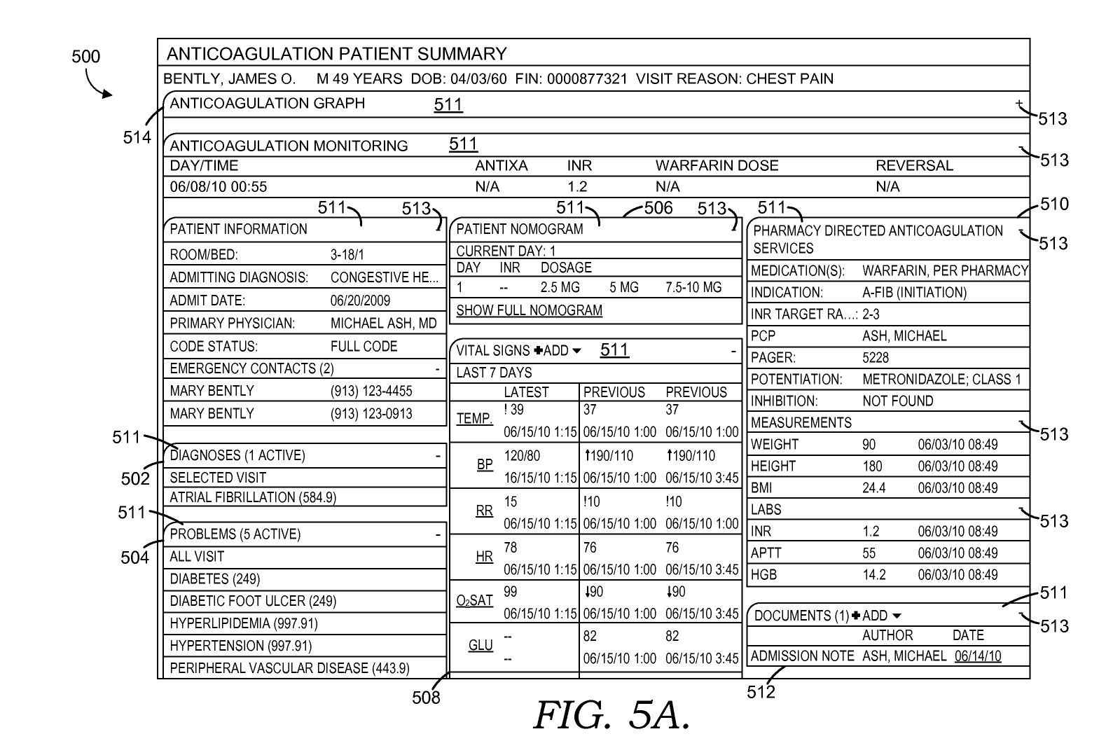

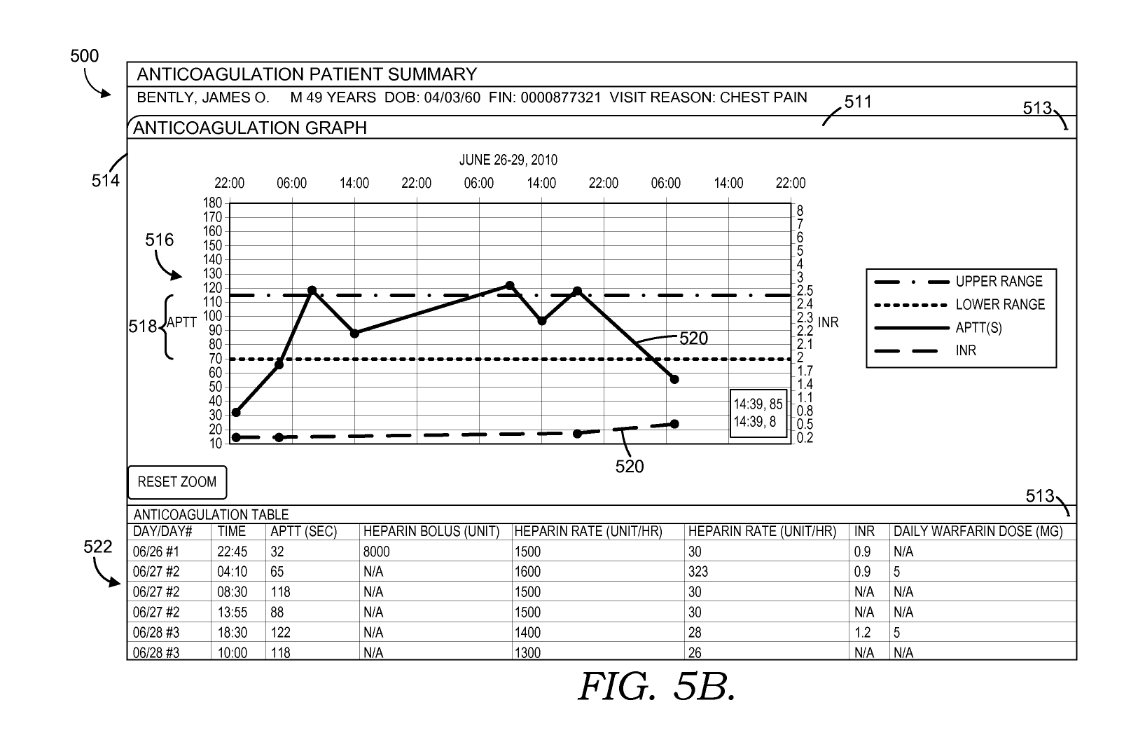

With additional reference now to FIGS. 4A-5B exemplary embodiments of a GUI for use in managing anticoagulant patients are described. In an embodiment the consolidated list generated, for example, by the list-generation component 308 is a work list 400 for a pharmacist, as depicted in FIGS. 4A-C. The work list 400 provides the pharmacist with a single reference list of anticoagulant patients 402 that are being overseen by the pharmacist, another pharmacist, or the pharmacy department generally. The work list 400 includes a “PATIENT INFORMATION” field 403 that provides general information regarding an anticoagulant patient 402, an “ACTIVITIES” field 404 that indicates activities that are completed or that need to be completed by the pharmacist, an “INDICATION” field 406 that indicates a reason for treatment of a patient 402 with anticoagulants, a “MEDICATIONS” field 408 that indicates anticoagulants prescribed for a patient 402, a “LABS” field 410 that provides laboratory test values, and a “BASELINE” field 412 that indicates one or more baseline laboratory test values. The work list 400 might also provide a “LAST REVIEW” field 414 that describes when and by whom a patient 402 was last seen, a “NOTES” field 416 that provides access to documentation provided by clinicians caring for a patient 402, and a selectable “REVIEW” field 418 that can be selected by the pharmacist to indicate anticoagulant patients 402 that the pharmacist wishes to visit or follow up on. The work list 400 is sortable based on any field 403-418 to allow the pharmacist to view and organized the information as desired.

In an embodiment, a pharmacist decides to visit anticoagulant patients 402 from the work list 400 based on activities that are indicated as incomplete. During or following the visit, the pharmacist may collect additional information and document anticoagulant treatment characteristics, symptoms, or other information via the work list 400 and the “NOTES” field 416. The pharmacist may also provide education to the patient 402 regarding anticoagulant medications. For example, the pharmacist might explain the interaction of certain foods with anticoagulant medications. In an embodiment, the pharmacist's time spent with the patient 402 is a billable revenue source for the healthcare facility.

In another embodiment, the work list 400 provides additional information associated with the anticoagulant patients 402 as a result of a user interaction with the work list 400. For example, as depicted in FIG. 4B, a clinician provides an input to the “BASELINE” field 412 for the fictional anticoagulant patient 402 Barbara Ashton. The input comprises any available input, such as, for example, a hover of an arrow icon 420 associated with a mouse input device, a click of a mouse, or a tap input to a touch screen, among a variety of others. The input causes a pop-up window 422 to be superimposed over the work list 400. The pop-up window 422 provides additional information associated with the anticoagulant patient's baseline laboratory test results as well as other personal identifying information for the patient 402.

Another example of providing additional information associated with the anticoagulant patients 402 as a result of a user interaction with the work list 400 is depicted in FIG. 4C. FIG. 4C depicts a second pop-up window 424 that is presented as a result of a clinician providing an input, such as a mouse click to the “MEDICATIONS” field 408 or the “LABS” field 410 for the fictional anticoagulant patient 402, James O. Bentley. The pop-up window 424 provides guidelines 426 for warfarin reversal that are useable by the clinician to identify a proper course of treatment to bring laboratory test results for the anticoagulant patient 402 back into a desired or recommend range. Upon determining an appropriate course of treatment, the clinician can then input orders for any changes in dosages or treatments and provide any desired documentation via the fields 404-418 of the work list 400. Any orders, documentation, or other inputs to the work list 400 are stored in the EMR for the respective anticoagulant patient and are made available via the EMR to other clinicians involved in the care of the patient. As such, an entire treating team of clinicians are provided with up-to-date, comprehensive information associated with the anticoagulant patient.

With additional reference to FIG. 5A, an anticoagulant patient summary window 500 is depicted. In an embodiment, the window 500 is presented in response to a clinician providing an input to the “PATIENT INFORMATION” field 403 of the work list 400, as depicted in FIGS. 4A-C. For example, the clinician might select a link 426 or hyperlink associated with the fictional anticoagulant patient, James O. Bentley's name. The window 500 provides additional and/or more in depth information regarding anticoagulant treatment of an anticoagulant patient. In an embodiment, the additional information includes active diagnosis 502, symptoms or problems 504 exhibited by the anticoagulant patient, a patient nomogram 506 depicting anticoagulant medication provisions to the patient, patient vital signs 508, general information 510 on the patient and treating clinicians, as well as documentation 512 of the patient's care provided by clinicians. The additional information 502-512 may be provided in any desired format including expandable panes within the window 500, as depicted in FIG. 5A. The expandable panes are expanded and minimized to a title bar 511 by selecting an icon 513.

The summary window 500 also includes an expandable pane 514 that provides an anticoagulation graph 516, as depicted in FIG. 5B. The anticoagulation graph 516 depicts a desired range 518 for laboratory test values as well as a plot 520 of one or more anticoagulant medications employed in the treatment of an anticoagulant patient. In an embodiment, the pane 514 also includes a table 522 of the data comprising the anticoagulation graph 516. As such, a clinician is provided with a visual representation by which to track weaning and onset of anticoagulant medications and to correlate laboratory test values with desired treatment ranges.

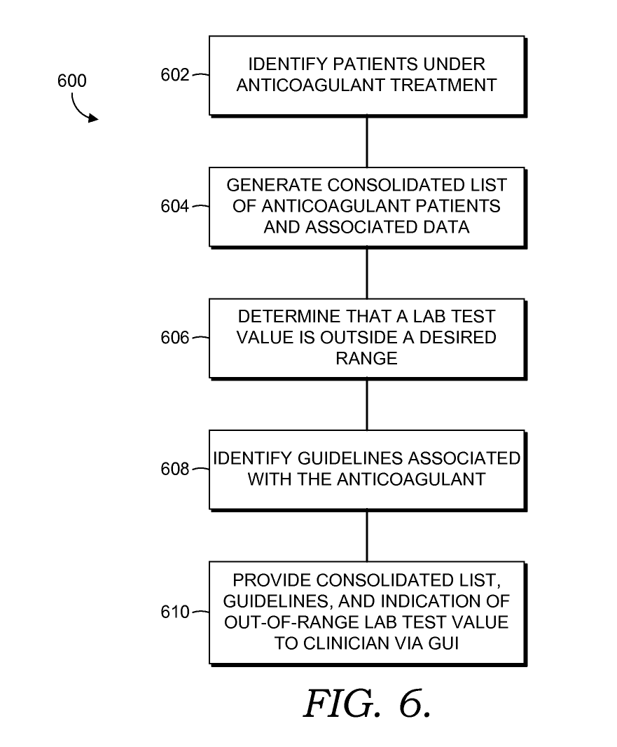

With reference now to FIG. 6, a method 600 for managing anticoagulation treatment for a patient is described in accordance with an embodiment of the invention. At a step 602, patients taking anticoagulant medications or for which an anticoagulant medication has been ordered are identified based on data elements included in an EMR associated with the respective patient. A consolidated list of the identified anticoagulant patients is generated, at a step 604. The consolidated list includes identifying information for each of the identified anticoagulant patients as well as indications of anticoagulant medications prescribed for the patient, an indication or reason for the prescription, and a laboratory test result value associated with the anticoagulant medications, among other data elements obtained from the EMR as described above. In an embodiment, potential risk factors associated with providing anticoagulant medications to a patient are also identified based on EMR data for the patient, guidelines, and known drug interactions, as described previously above.

At a step 606, a determination is made that a laboratory test value falls outside a desired therapeutic range for anticoagulant treatment of a patient. The desired therapeutic range is set by a clinician as desired or based on one or more guidelines, protocols, or recommendations. At a step 608, one or more guidelines, protocols, or recommendations associated with an anticoagulant prescribed to the patient are identified.

The consolidated list of anticoagulant patients and the identified guidelines are provided to a clinician, at a step 610. In an embodiment, the identified guidelines are selectively provided to the clinician by way of one or more pop-up windows, links, or expandable panes that are presented in response to an input from the clinician. The clinician might also be provided with an alert that identifies the anticoagulant patient and indicates that an out-of-range laboratory test result has been received.

In an embodiment, the clinician employs the guidelines and data provided in the consolidated list to determine a new dosage or anticoagulant medication to be prescribed for the patient to correct the out-of-range laboratory test result value. In another embodiment, a new dosage of the anticoagulant medication is automatically calculated based on one or more guidelines or protocols and is provided with an alert to the clinician. An order for the new dosage, additional laboratory tests, or a diet specifically tailored for patients receiving anticoagulant therapy might also be automatically entered on behalf of the clinician.

Many different arrangements of the various components depicted, as well as components not shown, are possible without departing from the scope of the claims below. Embodiments of the technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

The invention claimed is:

1. One or more computer-readable storage media having computer-executable instructions embodied thereon that, when executed, perform a of method for managing anticoagulation treatment for a patient, the method comprising:
identifying a patient that is taking an anticoagulant medication or for which an anticoagulant medication has been ordered, the identifying based on data elements in an electronic medical record (EMR) associated with the patient;
determining that a laboratory test value for the patient is outside a desired range;
identifying guidelines associated with the anticoagulant medication; and
providing an indication of the patient, one or more data elements associated with the patient, the guidelines, and an indication of the laboratory test value to a clinician via a graphical user interface (GUI).

2. The media of claim 1, further comprising:
identifying a potential risk factor associated with providing anticoagulant medications to the patient based on one or more of data elements in the EMR associated with the patient and guidelines associated with the anticoagulant medications.

3. The media of claim 2, wherein the data elements in the EMR associated with the patient include one or more of the patient's medical history records, a diagnosis, a laboratory test value, and a medical procedure scheduled for the patient.

4. The media of claim 2, wherein the guidelines associated with the anticoagulant medications include a list of one or more of medications, foods, and substances that are known to potentiate or inhibit anticoagulant medications in the human body, and guidelines for prescribing and managing dosages of anticoagulant medications.

5. The media of claim 1, further comprising:
generating a consolidated list of a plurality of patients that are receiving anticoagulant medications, the plurality of patients including the patient, and the list including for each of the plurality of patients an indication of one or more of an anticoagulant medication prescribed for the patient, a reason for the anticoagulant medication being prescribed, and a lab value that represents the efficacy of the anticoagulant medication treatment in a respective patient.

6. The media of claim 5, further comprising:
calculating a new dosage of the anticoagulant medication based on one or more guidelines associated with the provision of the anticoagulant medication to patients and based on characteristics of supplies of the anticoagulant medication available to patients of the healthcare facility;
providing the new dosage of the anticoagulant medication to the clinician.

7. The media of claim 1, wherein providing the guidelines to a clinician via a GUI further comprises:
in response to a user interaction with the GUI, providing one or more of a pop-up window and a link to a page that includes the identified guidelines associated with the anticoagulant medication.

8. The media of claim 7, wherein the clinician identifies a new dosage for the anticoagulant medication from the provided guidelines and enters orders for the new dosage via the GUI.

9. The media of claim 1, further comprising one or more of automatically:
ordering an appropriate laboratory test,
ordering an appropriate anticoagulant medication or dosage based on a laboratory test result and a guideline, and
ordering a diet for the patient that is recommended by a guideline.

10. One or more computer-readable storage media having computer-executable instructions embodied thereon that, when executed, provide a system for managing anticoagulant medications for patients in a healthcare facility, the system comprising:
an anticoagulant-patient identification component that identifies a patient in a healthcare facility that is currently prescribed an anticoagulant medication or for which an order has been placed for an anticoagulant medication based on data elements stored in an electronic medical record (EMR) associated with the patient and that gathers data elements related to the care of the anticoagulant patient from the EMR;
a risk-assessment component that identifies potential risk factors for treatment of the anticoagulant patient with a given anticoagulant medication;
an advisor component that determines a guideline associated with the anticoagulant medication prescribed to the anticoagulant patient and provides the guideline to a clinician;
a list-generation component that generates a consolidated list of a plurality of anticoagulant patients and related data elements, wherein the related data elements include at least an identification of at least one anticoagulant medication prescribed for the patient, a reason the patient is prescribed the anticoagulant medication, and a lab value associated with the anticoagulant medication; and
a presentation component that provides a centralized graphical user interface (GUI) from which a clinician accesses the consolidated list, potential risk factors, and guidelines.

11. The media of claim 10, wherein the system further comprises:
an activities component that generates a list of activities to be completed for each of the plurality of anticoagulant patients, the activities including one or more of visiting a patient, educating a patient, ordering laboratory tests, and reviewing laboratory test results.

12. The media of claim 10, wherein the risk-assessment component automatically identifies potential risk factors for treatment of the anticoagulant patient with a given anticoagulant medication based on one or more of the patient's medical history records, a diagnosis, a laboratory test value, and a medical procedure scheduled for the patient.

13. The media of claim 10, wherein the risk-assessment component automatically identifies potential risk factors for treatment of the anticoagulant patient with a given anticoagulant medication based on one or more of a list of medications, foods, or substances that are known to potentiate or inhibit anticoagulant medications in the human body, and guidelines for prescribing and managing dosages of anticoagulant medications

14. The media of claim 10, wherein the clinician is a pharmacist, and wherein the centralized GUI allows the pharmacist to more quickly identify anticoagulant patients that need to be seen than if the pharmacist were required to gather information related to anticoagulant patients from multiple sources.

15. The media of claim 10, wherein the guideline is provided to the clinician in response to a user interaction with the centralized GUI, the user interaction comprising one or more of a hover, a click, and a carriage return.

16. The media of claim 10, wherein the GUI includes a link for each of the plurality of anticoagulant patients in the consolidated list to a patient specific view that includes at least a summary of information associated with anticoagulant treatment for a specific patient, an indication of one or more anticoagulants prescribed for the patient, and a nomogram depicting anticoagulant treatment variables and laboratory test results for the specific patient.

17. The media of claim 16, wherein the patient specific view also includes one or more of a graph and a chart depicting a desired laboratory test result range for the specific patient, a laboratory test result, and a dosage of an anticoagulant medication prescribed for the specific patient.

18. The media of claim 10, wherein a clinician completes one or more of changing a prescribed dosage, setting a desired therapeutic range, documenting treatment of the anticoagulant patient, and ordering treatments for the anticoagulant patient via the GUI.

19. A graphical user interface (GUI) stored on one or more computer-readable media and executable by a computing device having a processor for providing a consolidated presentation of data from electronic medical records (EMR) associated with each of a plurality of patients receiving an anticoagulant medication in a healthcare facility, the GUI comprising:
a first display area configured to display patient information for each of a plurality of patients receiving an anticoagulant medication in a healthcare facility including patient identification information;
a second display area configured to display an indication of a reason each of the plurality of patients is receiving the anticoagulant medication;
a third display area configured to display the anticoagulant medication prescribed to each of the plurality of patients;
a fourth display area configured to display at least one lab result associated with the prescribed anticoagulant medication; and
a fifth display area configured to display an indication of a clinician that last followed up on a respective patient, and to provide access to notes regarding the care of the respective patient.

20. The graphical user interface of claim 19, further comprising one or more of:
a sixth display area configured to display an indicator depicting a status of tasks to be completed for the respective patient;
a seventh display area configured to provide one or more baseline lab values for the respective patient and an indication of whether a current lab value is within or outside of a designated range for the respective patient; and
an eighth display area configured to provide a selectable field to be used by a clinician for identifying one or more of the plurality of patients on which the clinician desires to round.
